(19) United States
(12) Patent Application Publication
(10) Pub. No.: US 2025/0278199 A1
(43) Pub. Date: Sep. 4, 2025

(54) VARIABLE-LENGTH CONSTRAINT ENCODING TO IMPROVE ENDURANCE

(71) Applicant: Micron Technology, Inc., Boise, ID (US)

(72) Inventors: Sundararajan Sankaranarayanan, Fremont, CA (US); Xiangyu Tang, San Jose, CA (US); Huai-Yuan Tseng, San Ramon, CA (US); Akira Goda, Meguro (JP)

(21) Appl. No.: 19/060,221

(22) Filed: Feb. 21, 2025

Related U.S. Application Data
(60) Provisional application No. 63/560,444, filed on Mar. 1, 2024.

(51) Int. Cl. G06F 3/06

(52) U.S. Cl. CPC G06F 3/0616; G06F 3/0619; G06F 3/0659; G06F 3/0679

(57) ABSTRACT

A command to write data to a memory device is received. Based on the command, the data is encoded using a variable-length constraint encoding scheme. The encoding of the data includes generating a codeword based on a bit sequence from the data. The number of logical one bits in the codeword corresponds to an integer equivalent of the bit sequence. Encoded data that includes the codeword is programmed to the memory device.

### PRIORITY APPLICATION

This application claims the benefit of priority to U.S. Provisional Application Ser. No. 63/560,444, filed Mar. 1, 2024, which is incorporated herein by reference in its entirety.

### TECHNICAL FIELD

Embodiments of the disclosure relate generally to memory sub-systems and more specifically to a variable-length constraint encoding to improve endurance of memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 is a diagram illustrating an example computing system that includes a memory sub-system, in accordance with some embodiments of the present disclosure.

FIG. 2 is a diagram illustrating example interactions between components of the memory sub-system in performing a variable-length constraint encoding and decoding of data, in accordance with some embodiments of the present disclosure.

FIGS. 3 and 4 are flowcharts illustrating an example method in performing a variable-length constraint encoding of data, in accordance with some embodiments of the present disclosure.

FIG. 5 is a diagram of an example computer system in which embodiments of the present disclosure may operate.

### DETAILED DESCRIPTION

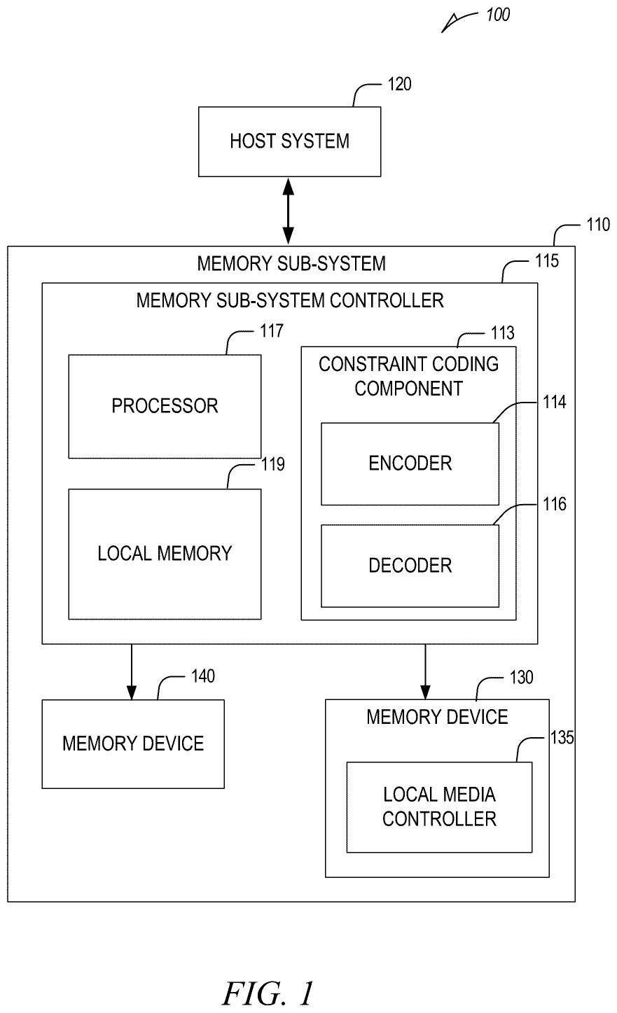

Aspects of the present disclosure are directed to an approach for encoding data stored by a memory device in a memory sub-system using a variable-length encoding scheme. A memory sub-system can be a storage device (e.g., solid-state drive (SSD)), a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes and each plane includes multiple blocks. Each block includes an array that includes pages (rows) and strings (columns). A string includes a plurality of memory cells connected in series. A memory cell (“cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values. Other examples of non-volatile memory devices are described below in conjunction with FIG. 1.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increase until a target voltage level for each cell is reached.

A key performance metric for memory devices, such as NAND memory devices, is endurance, which refers to the number of program/erase cycles for which a block can reliably store data. For example, endurance can be quantified in terms of terabytes written (TBW), which measures the total amount of data that can be programmed (written) to a memory device over its lifetime. Memory device endurance is limited due to damage accumulation in the tunnel oxide layer of memory cells during repeated program/erase cycling. Eventually, the inability to reliably store data leads to device failures.

A conventional approach to improve endurance relies on low-density parity check (LDPC) codes. LDPC codes are a class of linear error correcting codes (ECC) that can recover data in the presence of errors by introducing redundancy. However, the use of LDPC codes comes at the cost of lower storage density due to the added redundant bits.

Other prior approaches focus on directly reducing damage accumulation during programming and erasing to improve endurance. For example, some methods optimize program and erase voltage parameters to minimize oxide degradation. Another example prior approach involves modifying the memory cell structure to make it more resistant to cycling damage. However, these empirical methods have resulted in only modest endurance gains.

Aspects of the present disclosure address the forgoing issues with a memory sub-system that utilizes a variable-length constraint encoding scheme that is tailored to minimize the likelihood of cells being in a programmed state. By minimizing the likelihood that cells will be in the programmed state, damage accumulation is lowered significantly per program/erase cycle thereby enhancing total endurance of the memory device (TBW) compared with prior techniques.

In an example, a command to write data is received by a memory sub-system controller. A constraint coding component of the memory sub-system encodes the data using the variable-length constraint encoding scheme that minimizes the probability of cells being programmed. In performing the encoding, the constraint coding component parses the data into N-bit sequences and generates a codeword for each N-bit sequence. For a given codeword, the number of bits with the value of one (also referred to herein as “one bits”) in the codeword corresponds to an integer equivalent of the corresponding bit sequence.

The memory sub-system controller programs the variable-length encoded data to cells of a memory device. As noted above, the variable-length encoding scheme reduces the number of programmed states (corresponding to a value of zero) versus erased states (corresponding to a value of one) to decrease damage accumulation and increase endurance substantially compared to typical programming techniques that balance zero and one states.

In retrieving the data responsive to a read command, the memory sub-system controller reads the variable-length encoded data and the constraint coding component decodes it by counting the number of cells in an erased state between programmed cells to recover the original bit sequences.

While the variable-length constraint encoding scheme discussed herein is applicable to all NAND cell types (e.g., SLC, TLC, QLC, MLC, etc.), the encoding schemes has particularly useful applicability to SLC NAND cells. As referenced above, in SLC NAND, each cell stores 1 bit of information, with one programmed state (0) and one erased state (1). A key benefit of SLC NAND is its higher endurance compared to MLC and TLC NAND that store multiple bits per cell. However, the endurance of SLC NAND is still limited by damage accumulation in the tunnel oxide layer during program/erase cycles. The variable-length constraint encoding is tailored to reduce exposure of SLC cells to the high voltage damage-causing programmed state. By reducing the likelihood of programmed states versus erased states, damage is lowered, and endurance is increased significantly.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can be coupled to the memory sub-system 110 via a host interface. Examples of a host interface include, but are not limited to, a SATA interface, a PCIe interface, USB interface, Fibre Channel, Serial Attached SCSI (SAS), Small Computer System Interface (SCSI), a double data rate (DDR) memory bus, a DIMM interface (e.g., DIMM socket interface that supports DDR), ONFI, Low Power Double Data Rate (LPDDR), or any other interface. The host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NAND type flash memory and write-in-place memory, such as a three-dimensional cross-point (3D cross-point) memory device, which is a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and 3D NAND.

Each of the memory devices 130 can include one or more arrays of memory cells. One type of memory cell, for example, single level cells (SLC), can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. For example, the memory device can include a set of blocks. Design specifications may define a constraint on a minimum number of valid blocks for the memory device 130 that may be different from the number of blocks in the set of blocks on the device.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOR flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 and convert responses associated with the memory devices 130 and/or the memory device 140 into information for the host system 120.

In some embodiments, the memory devices 130 include local media controllers 135 that operate in conjunction with memory sub-system controller 115 to execute operations on one or more memory cells of the memory devices 130.

The memory sub-system 110 also includes a constraint coding component 113 that is responsible for encoding and decoding data based on a variable-length constraint encoding scheme. To this end, the constraint coding component 113 includes an encoder 114 to encode data based on the variable-length constraint encoding scheme and a decoder 116 to decode encoded data based on the variable-length constraint encoding scheme. Further details regarding the constraint coding component 113 and the variable-length constraint encoding scheme are discussed below.

In some embodiments, the local media controller 135 includes at least a portion of the constraint coding component 113. For example, the local media controller 135 may work in conjunction with the constraint coding component 113 to perform one or more operations to support variable-length constraint encoding and decoding at the memory device 130. In addition, the memory sub-system controller 115 can include a processor 117 (processing device) configured to execute instructions stored in local memory 119 for performing one or more operations to support variable-length constraint encoding and decoding at the memory device 130.

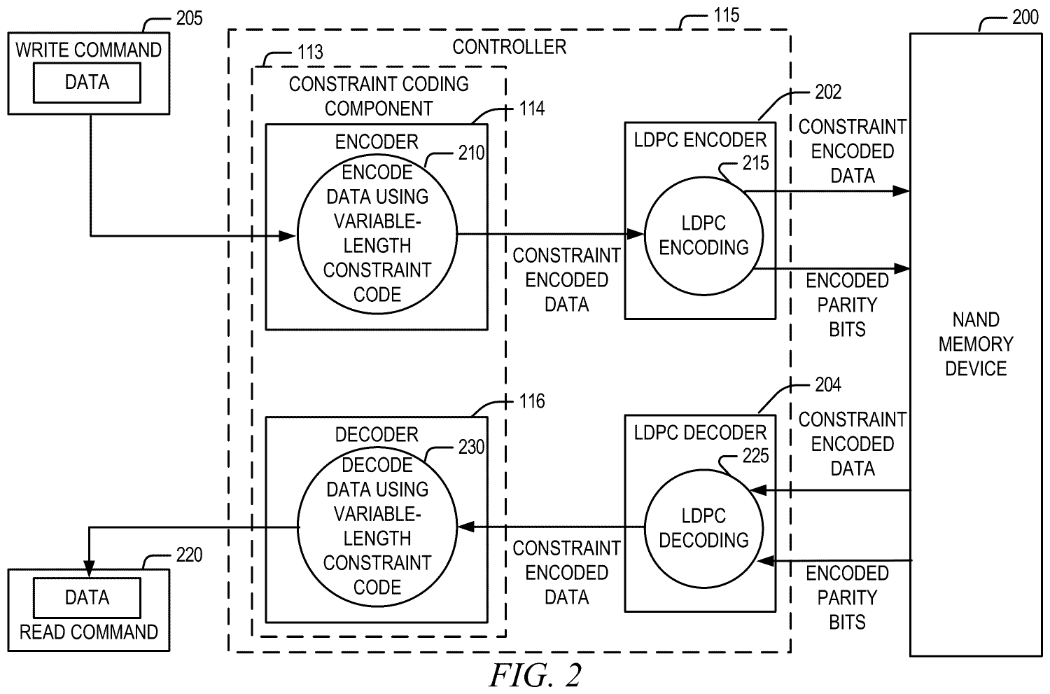

FIG. 2 is a diagram illustrating example interactions between components of the memory sub-system 110 in performing a variable-length constraint encoding and decoding of data, in accordance with some embodiments of the present disclosure. In the example illustrated in FIG. 2, the memory device 130 of FIG. 1 is in the example form of a NAND memory device 200 that includes NAND memory. The NAND memory includes multiple NAND dies; each die may include one or more planes, each of which includes multiple blocks. Each block includes a 2D or 3D array that includes pages (rows) and strings (columns). A string includes a plurality of memory cells connected in series. Each memory cell is used to represent one or more bit values. Each cell includes a transistor, and within each cell, data is stored as the threshold voltage of the transistor.

A single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory 201 includes an SLC portion that includes multiple SLCs and a MLC portion that includes multiple MLCs.

Within the NAND memory, strings are connected within a NAND block to allow storage and retrieval of data from selected cells. NAND cells in the same column are connected in series to form a bit line (BL). All cells in a bit line are connected to a common ground on one end and a common sensing amplifier on the other for reading the threshold voltage of one of the cells when decoding data. NAND cells are connected horizontally at their control gates to a word line (WL) to form a page. In MLC, TLC, QLC, and PLC NAND, a page is a set of connected cells that share the same word line and is the minimum unit to program.

As noted above, each NAND cell stores data in the form of the threshold voltage (V_{T}) of the transistor. The range of threshold voltages of a memory cell can be divided into a number of regions based on the number of bits stored by the cell where each region corresponds to a value that can be represented by the cell. More specifically, each region corresponds to a charge level (also referred to herein as “read level”) and each charge level decodes into a multi-bit value. For example, a TLC NAND flash cell can be at one of eight charge levels: L0, L1, L2, L3, L4, L5, L6, or L7. For TLC NAND, each charge level decodes into a 3-bit value that is stored in the flash cell (e.g., 111, 110, 100, 000, 010, 011, 001, and 101). As another example, a SLC NAND flash cell can be at one of two charge levels: L0 or L1. For SLC NAND, each charge level decodes into a single bit value that is stored in the flash cell (e.g., 1 or 0).

During write operations, data is programmed into a block of the NAND memory of the NAND device 200 using a programming sequence that includes multiple passes in which programming pulses are applied to cells in the block. Over the multiple passes, the programming pulses configure the threshold voltages of the cells in each page according to the value the cells are intended to represent. As the programming sequence progresses, the voltage level of the programming pulses increase until a target voltage level for each cell (also referred to as “write level” herein) is reached. The multiple passes may include a coarse programming pass and a fine programming pass. During the coarse programming pass, threshold voltages of cells are configured to approximate the target voltage level for each cell, while in the fine programming pass, threshold voltages of cells are configured more precisely according to the target voltage level for each cell.

In addition, in the example illustrated by FIG. 2, the controller 115 further comprises a low-density parity check (LDPC) encoder 202 and LDPC encoder 204 that are responsible for performing LDPC encoding and decoding, as will be discussed below.

As shown, a write command 205 to program (write) data to the memory device 200 is received by controller 113 (e.g., from a host system 120). In an example, the data is to be programmed to an SLC block in the SLC portion of the memory device 200. In this example, the command may specify that the data is to be written to the SLC portion or the controller 113 may make the determination to write the data to the SLC portion based on the command.

At operation 210, the encoder 114 of the constraint coding component 113 encodes the data using a variable-length constraint encoding scheme, which results in variable-length constraint encoded data. In encoding the data, the encoder parses the data into bit sequences of N-bits (also referred to herein as “N-bit sequences”) and generates a codeword for each N-bit sequence. For the encoding scheme used by the encoder 114, the minimum length of codewords is two bits and the maximum length of codewords is 2^{N} bits. In an example, the encoder 114 may generate a first codeword for a first bit sequence (of N bits) that is a first length and the encoder 114 may further generate a second codeword for a second bit sequence (of N bits) that is a second length that is different from the first length.

For a given N-bit sequence, the codeword generated by the encoder 114 comprises a number of logical one bits (bits with a value of “1”) corresponding to an integer equivalent of the bit sequence and a single logical zero bit (a bit with a value of “0”) to serve as a delimiter between sequences of logical one bits. In this manner, the number of logical one bits (bit values of “1”) serves as an encoding that can be used to determine a bit sequence while the logical zero bit is used as a delimiter between bit sequence encodings. In an example where Nis 3, the processing device generates codewords for each 3-bit sequence in the data according to Table 1 presented below.

TABLE 1

| N-Bit Sequence (N = 3) | Integer Equivalent | Codeword |
|---|---|---|
| 000 | 0 | 0 |
| 001 | 1 | 10 |
| 010 | 2 | 110 |
| 011 | 3 | 1110 |
| 100 | 4 | 11110 |
| 101 | 5 | 111110 |
| 110 | 6 | 1111110 |
| 111 | 7 | 11111110 |

At operation 215, the LDPC encoder 204 performs LDPC encoding of the variable-length encoded data. At operation 220, the controller 115 programs (writes) the variable-length encoded data and encoded parity data resulting from the LDPC encoding to the SLC block of the memory device 200. The variable-length constraint encoding scheme used by the variable-length constrain code component 113 decreases the probability that a given cell in the SLC portion of the memory device 200 will be placed in a programmed state to reflect a logical zero bit. Hence, based on utilization of the variable-length constraint encoding scheme in encoding the data programmed to the SLC block, a number of cells programmed to store a one is expected to be greater than a number of cells programmed to store a zero.

As shown, the controller 115 receives a command 220 to read the data from the memory device 200. Based on the read command 220, the controller 115 reads the encoded data (the variable-length encoded data and the encoded parity data) from the SLC block of the memory device 200.

At operation 225, the LDPC decoder 204 performs an LDPC decoding of the encoded data to correct one or more bits in error, and at operation 230, the decoder 116 decodes the variable-length constraint encoded data according to the variable-length encoding scheme used to encode the data. In decoding the encoding data, the decoder 116 determines the bit sequences corresponding to each codeword stored as part of the encoded data. For a given codeword, the decoder 116 counts the number of logical one bits to determine the integer equivalent of the bit sequence and the processing device determines the bit sequence based on the integer equivalent. More specifically, to determine each sequence of N bits in the requested data, the processing device may count the number of cells that are in an erased state (“1”) between cells in a programmed state (“0”) at the location of the encoded data in an SLC block of the memory device 200.

At operation 230, the controller provides the (decoded) data to the host system 120 in response to the command.

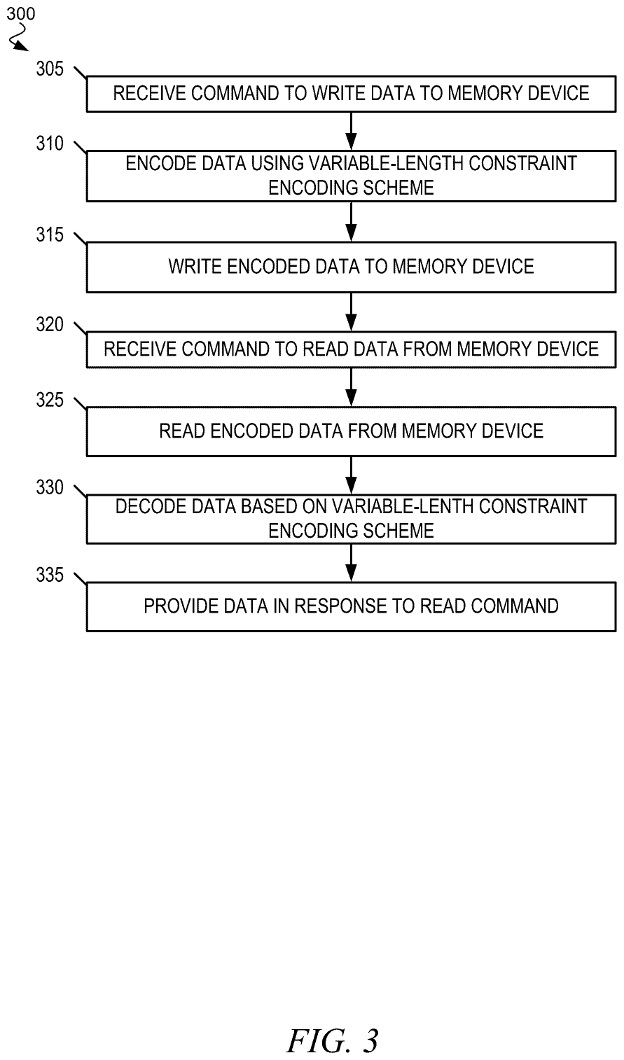

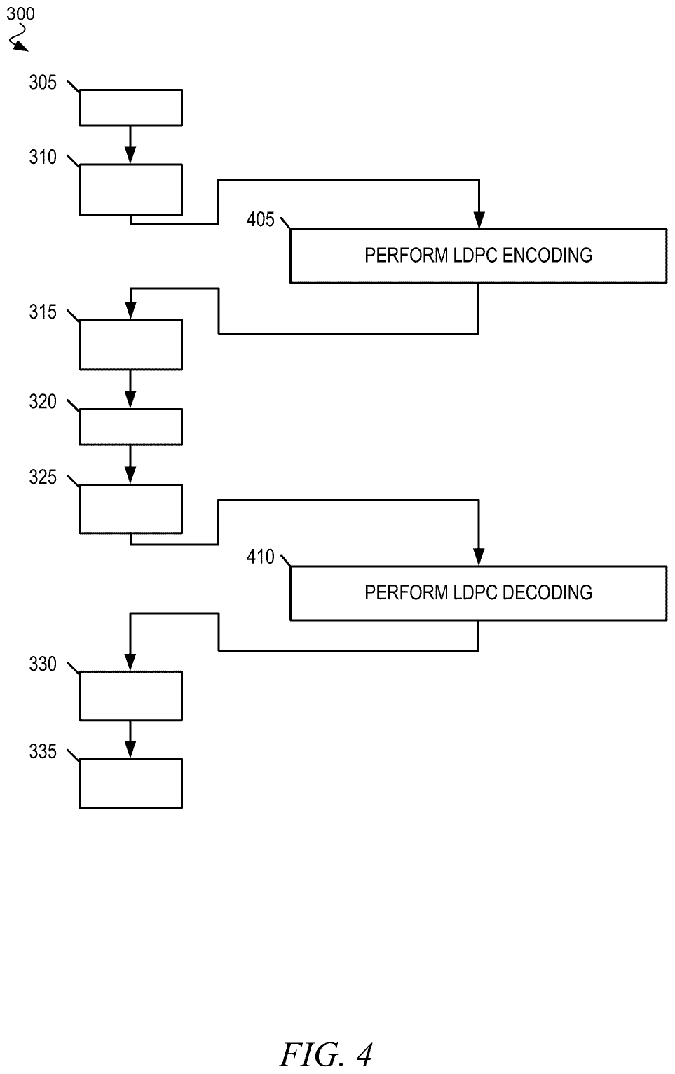

FIGS. 3 and 4 are flowcharts illustrating an example method 300 in performing a variable-length constraint encoding of data, in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed at least in part by touchup sub-system 150 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives a command to write data to a memory device (e.g., the memory device 130). In an example, the data is to be written to an SLC portion of the memory device (e.g., a block in the memory device containing SLCs). In this example, the command may specify that the data is to be written to the SLC portion or the processing device may make the determination to write the data to the SLC portion based on the command.

At operation 310, the processing device encodes the data using a variable-length constraint encoding scheme. In encoding the data, the processing device parses the data into one or more bit sequences each having N bits and generates a codeword for each bit sequence. Based on the encoding scheme used by the processing device, for bit sequences of N length, the minimum length of codewords is two bits and the maximum length of codewords is 2˜ bits. Accordingly, in encoding the data, the processing device may generate a first codeword for a first bit sequence (of N bits) that is a first length and the processing device may further generate a second codeword for a second bit sequence (of N bits) that is a second length that is different from the first length.

For a given bit sequence, the codeword generated by the processing device comprises a single logical zero bit (“0”) and a number of logical one bits (“1”) corresponding to an integer equivalent of the bit sequence. In an example where N is 3, the processing device generates codewords for each 3-bit sequence in the data according to Table 1 discussed above.

At operation 315, the processing device writes (programs) the encoded data to the memory device. In an example, the processing device writes the encoded data to an SLC block of the memory device. By encoding the data using the variable-length constraint encoding discussed above, the processing device decreases the probability that a given cell in the memory device (or more specifically a given SLC in an SLC block of the memory device) will be placed in a programmed state (“0”) to reflect a logical zero bit. Hence, based on utilization of the variable-length constraint encoding, a number of logical one bits in the encoded data is greater than a number of logical zero bits in the encoded data.

The processing device, at operation 320, receives a command to read the data from the memory device. Based on the command, the processing device reads the encoded data from the memory device (e.g., from the SLC block of the memory device), at operation 325, and at operation 330, the processing device decodes the encoded data according to the variable-length encoding scheme used to encode the data. In decoding the encoding data, the processing device determines the bit sequences corresponding to each codeword stored as part of the encoded data. For a given codeword, the processing device counts the number of logical one bits to determine the integer equivalent of the bit sequence and the processing device determines the bit sequence based on the integer equivalent. More specifically, to determine each sequence of N bits in the requested data, the processing device may count the number of cells that are in an erased state (“1”) between cells in a programmed state (“0”) at the location of the encoded data in an SLC block of the memory device.

At operation 335, the processing device provides the data in response to the command.

As shown in FIG. 4, the method 300 may further include operations 405 and 410, according to some examples. Consistent with these example, the operation 405 may be performed prior to operation 315 where the processing device writes the encoded data to the memory device. At operation 405, the processing device performs an LDPC encoding of the encoded data (encoded based on the variable-length constraint encoding scheme).

Consistent with these examples, the operation 410 can be performed prior operation 330 where the processing device decodes the encoded data according to the variable-length encoding scheme. At operation 410, the processing device performs an LDPC decoding of the encoded data.

In view of the disclosure above, various examples are set forth below. It should be noted that one or more features of an example, taken in isolation or combination, should be considered within the disclosure of this application.

Example 1. A memory sub-system comprising: a memory device; and a processing device, operatively coupled with the memory device to perform operations comprising: receiving a command to write data to the memory device; based on receiving the command, encoding the data using a variable-length constraint encoding scheme, the encoding of the data including generating a codeword based on a bit sequence from the data, a number of logical one bits in the codeword corresponding to an integer equivalent of the bit sequence; and programming encoded data based on the data to the memory device, the encoded data including the codeword.

Example 2. The memory sub-system of claim 1, wherein the codeword includes a single logical zero bit.

Example 3. The memory sub-system of claim 1, wherein: the bit sequence comprises N bits; a minimum length of the codeword is two bits; and a maximum length of the codeword is 2N bits.

Example 4. The memory sub-system of claim 1, wherein: the bit sequence is a first bit sequence; the codeword is a first codeword having a first length; and the encoding of the data further including generating a second codeword based on a second bit sequence, a length of the second bit sequence being identical to a length of the first bit sequence, the second codeword having a second length that is different than the first length.

Example 5. The memory sub-system of claim 1, wherein a number of logical one bits in the encoded data is greater than a number of logical zero bits in the encoded data.

Example 6. The memory sub-system of claim 1, wherein: the memory device comprises a block of single level cells (SLCs); and the programming of the encoded data comprises programming the encoded data to the block of SLCs.

Example 7. The memory sub-system of claim 1, wherein the operations further comprise: receiving a command to read the data from the memory device; based on the command, accessing the encoded data from the memory device; decoding the encoded data based on the variable-length encoding scheme, the decoding of the encoded data comprising determining the bit sequence based on the number of logical one bits in the codeword; and providing the data responsive to the command to read the data.

Example 8. The memory sub-system of claim 1, wherein the operations further comprise: parsing the data into multiple bit sequences, wherein the encoded data includes multiple codewords corresponding to the multiple bit sequences.

Example 9. The memory sub-system of claim 1, wherein the operations further comprise: prior to storing the encoded data at the memory device, encoding the codeword using a low-density parity check (LDPC) encoding scheme.

Example 10. The memory sub-system of claim 9, wherein the operations further comprise: prior to decoding the encoded data based on the variable-length encoding scheme, performing LDPC decoding of the encoded data.

Example 11. A method comprising: receiving, by a processing device, a command to write data to a memory device; based on the command, encoding, by the processing device, the data using a variable-length constraint encoding scheme, the encoding of the data including: parsing the data into multiple bit sequences; generating a codeword based on a bit sequence from among the multiple bit sequences, a number of logical one bits in the codeword corresponding to an integer equivalent of the bit sequence; and programming encoded data based on the data to the memory device, the encoded data including the codeword.

Example 12. The method of claim 11, wherein the codeword includes a single logical zero bit.

Example 13. The method of claim 11, wherein: the bit sequence comprises N bits; a minimum length of the codeword is two bits; and a maximum length of the codeword is 2N bits.

Example 14. The method of claim 11, wherein: the bit sequence is a first bit sequence; the codeword is a first codeword having a first length; the encoding of the data further including generating a second codeword based on a second bit sequence, a length of the second bit sequence being identical to a length of the first bit sequence, the second codeword having a second length that is different than the first length.

Example 15. The method of claim 11, wherein a number of logical one bits in the encoded data is greater than a number of logical zero bits in the encoded data.

Example 16. The method of claim 11, wherein: the memory device comprises a block of single level cells (SLCs); and storing the encoded data in the block of SLCs.

Example 17. The method of claim 11, further comprising: receiving a command to read the data from the memory device; based on the command, reading the encoded data from the memory device; decoding the encoded data based on the variable-length encoding scheme, the decoding of the encoded data comprising determining the bit sequence based on the number of logical one bits in the codeword; and providing the data responsive to the command to read the data.

Example 18. The method of claim 11, further comprising parsing the data into multiple bit sequences.

Example 19. The method of claim 11, further comprising: prior to storing the encoded data at the memory device, encoding the codeword using a low-density parity check (LDPC) encoding scheme; and prior to decoding the encoded data based on the variable-length encoding scheme, performing LDPC decoding of the encoded data.

Example 20. A computer-readable storage medium comprising instructions that, when executed by a processing device, configure the processing device to perform operations comprising: receiving a first command to write data to a memory device; based on the first command, encoding the data using a variable-length constraint encoding scheme, the encoding of the data including generating a codeword based on a bit sequence from among multiple bit sequences, a number of logical one bits in the codeword corresponding to an integer equivalent of the bit sequence; programming encoded data based on the data to the memory device, the encoded data including the codeword; receiving a second command to read the data from the memory device; based on the second command, reading the encoded data from the memory device; decoding the encoded data based on the variable-length encoding scheme, the decoding of the encoded data comprising determining the bit sequence based on the number of logical one bits in the codeword; and providing the data responsive to the second command.

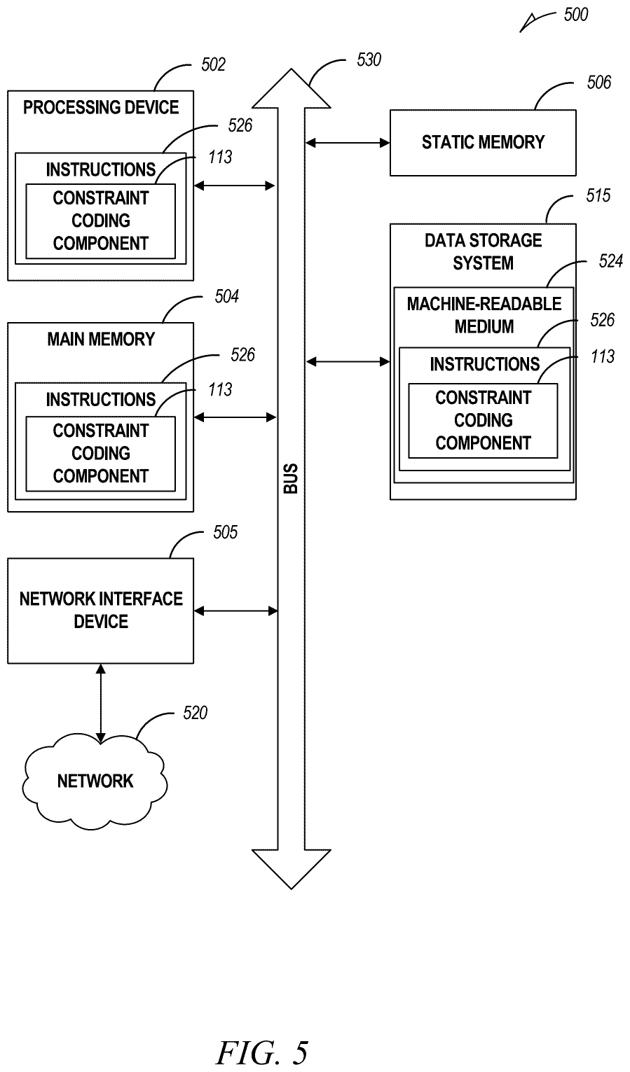

FIG. 5 illustrates an example machine in the form of a computer system 500 within which a set of instructions can be executed for causing the machine to perform any one or more of the methodologies discussed herein. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute operations to support touchup by the touchup sub-system 150 of the memory device 130 of FIG. 1 such as operations performed by the local media controller 135). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), a network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a constraint coding component (e.g., the constraint coding component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device; and
a processing device, operatively coupled with the memory device to perform operations comprising:
receiving a command to write data to the memory device;
based on receiving the command, encoding the data using a variable-length constraint encoding scheme, the encoding of the data including generating a codeword based on a bit sequence from the data, a number of logical one bits in the codeword corresponding to an integer equivalent of the bit sequence; and
programming encoded data based on the data to the memory device, the encoded data including the codeword.

2. The memory sub-system of claim 1, wherein the codeword includes a single logical zero bit.

3. The memory sub-system of claim 1, wherein:
the bit sequence comprises N bits;
a minimum length of the codeword is two bits; and
a maximum length of the codeword is 2^{N} bits.

4. The memory sub-system of claim 1, wherein:
the bit sequence is a first bit sequence;
the codeword is a first codeword having a first length; and
the encoding of the data further including generating a second codeword based on a second bit sequence, a length of the second bit sequence being identical to a length of the first bit sequence, the second codeword having a second length that is different than the first length.

5. The memory sub-system of claim 1, wherein a number of logical one bits in the encoded data is greater than a number of logical zero bits in the encoded data.

6. The memory sub-system of claim 1, wherein:
the memory device comprises a block of single level cells (SLCs); and
the programming of the encoded data comprises programming the encoded data to the block of SLCs.

7. The memory sub-system of claim 1, wherein the operations further comprise:
receiving a command to read the data from the memory device;
based on the command, accessing the encoded data from the memory device;
decoding the encoded data based on the variable-length encoding scheme, the decoding of the encoded data comprising determining the bit sequence based on the number of logical one bits in the codeword; and
providing the data responsive to the command to read the data.

8. The memory sub-system of claim 1, wherein the operations further comprise:
parsing the data into multiple bit sequences, wherein the encoded data includes multiple codewords corresponding to the multiple bit sequences.

9. The memory sub-system of claim 1, wherein the operations further comprise:
prior to storing the encoded data at the memory device, encoding the codeword using a low-density parity check (LDPC) encoding scheme.

10. The memory sub-system of claim 9, wherein the operations further comprise:
prior to decoding the encoded data based on the variable-length encoding scheme, performing LDPC decoding of the encoded data.

11. A method comprising:
receiving, by a processing device, a command to write data to a memory device;
based on the command, encoding, by the processing device, the data using a variable-length constraint encoding scheme, the encoding of the data including:
parsing the data into multiple bit sequences;
generating a codeword based on a bit sequence from among the multiple bit sequences, a number of logical one bits in the codeword corresponding to an integer equivalent of the bit sequence; and
programming encoded data based on the data to the memory device, the encoded data including the codeword.

12. The method of claim 11, wherein the codeword includes a single logical zero bit.

13. The method of claim 11, wherein:
the bit sequence comprises N bits;
a minimum length of the codeword is two bits; and
a maximum length of the codeword is 2^{N} bits.

14. The method of claim 11, wherein:
the bit sequence is a first bit sequence;
the codeword is a first codeword having a first length;
the encoding of the data further including generating a second codeword based on a second bit sequence, a length of the second bit sequence being identical to a length of the first bit sequence, the second codeword having a second length that is different than the first length.

15. The method of claim 11, wherein a number of logical one bits in the encoded data is greater than a number of logical zero bits in the encoded data.

16. The method of claim 11, wherein:
the memory device comprises a block of single level cells (SLCs); and
storing the encoded data in the block of SLCs.

17. The method of claim 11, further comprising:
receiving a command to read the data from the memory device;
based on the command, reading the encoded data from the memory device;
decoding the encoded data based on the variable-length encoding scheme, the decoding of the encoded data comprising determining the bit sequence based on the number of logical one bits in the codeword; and
providing the data responsive to the command to read the data.

18. The method of claim 11, further comprising parsing the data into multiple bit sequences.

19. The method of claim 11, further comprising:
prior to storing the encoded data at the memory device, encoding the codeword using a low-density parity check (LDPC) encoding scheme; and
prior to decoding the encoded data based on the variable-length encoding scheme, performing LDPC decoding of the encoded data.

20. A computer-readable storage medium comprising instructions that, when executed by a processing device, configure the processing device to perform operations comprising:
receiving a first command to write data to a memory device;
based on the first command, encoding the data using a variable-length constraint encoding scheme, the encoding of the data including generating a codeword based on a bit sequence from among multiple bit sequences, a number of logical one bits in the codeword corresponding to an integer equivalent of the bit sequence;
programming encoded data based on the data to the memory device, the encoded data including the codeword;
receiving a second command to read the data from the memory device;
based on the second command, reading the encoded data from the memory device;
decoding the encoded data based on the variable-length encoding scheme, the decoding of the encoded data comprising determining the bit sequence based on the number of logical one bits in the codeword; and
providing the data responsive to the second command.
